(19) United States
(12) Patent Application Publication
(10) Pub. No.: US 2024/0406998 A1
(43) Pub. Date: Dec. 5, 2024

(54) METHOD AND APPARATUS FOR LISTEN-BEFORE-TALK OPERATIONS IN SIDELINK COMMUNICATION OF UNLICENSED BAND

(71) Applicants: Hyundai Motor Company, Seoul (KR); Kia Corporation, Seoul (KR)

(72) Inventor: Ui Hyun Hong, Hwaseong (KR)

(21) Appl. No.: 18/803,152

(22) Filed: Aug. 13, 2024

Related U.S. Application Data
(63) Continuation of application No. PCT/KR2023/005186, filed on Apr. 17, 2023.

(30) Foreign Application Priority Data
Apr. 19, 2022 (KR) 10-2022-0048288
May 4, 2022 (KR) 10-2022-0055367

(51) Int. Cl. H04W 74/0808; H04W 74/00; H04W 92/18

(52) U.S. Cl. CPC H04W 74/0808; H04W 74/002; H04W 92/18

(57) ABSTRACT

A method and apparatus are operable for listen-before-talk (LBT) operations in sidelink communication of an unlicensed band. A method for operating a first user equipment (UE) includes steps of: receiving, by a processor, LBT configuration information; identifying, by the processor, an LBT duration on the basis of the LBT configuration information; performing, by the processor, an LBT operation in the LBT duration; and when the result of the LBT operation is an idle state, performing SL communication with a second UE.

### CROSS-REFERENCE TO RELATED APPLICATIONS

The present application is a continuation of International Application No. PCT/KR2023/005186 filed on Apr. 17, 2023, which claims under 35 U.S.C. § 119 (a) the benefit of Korean Patent Application No. 10-2022-0048288 filed on Apr. 19, 2022 and Korean Patent Application No. 10-2022-0055367 filed on May 4, 2022, the entire contents of which are incorporated by reference herein.

### BACKGROUND

### (a) Technical Field

The present disclosure relates to a sidelink communication technique in an unlicensed band, and more particularly, to a technique for listen-before-talk (LBT) operations.

### (b) Description of the Related Art

A communication network (e.g., 5G communication network or 6G communication network) is being developed to provide enhanced communication services compared to the existing communication networks (e.g., long term evolution (LTE), LTE-Advanced (LTE-A), etc.). The 5G communication network (e.g., New Radio (NR) communication network) can support frequency bands both below 6 GHz and above 6 GHZ. In other words, the 5G communication network can support both a frequency region 1 (FR1) and/or FR2 bands. Compared to the LTE communication network, the 5G communication network can support various communication services and scenarios. For example, usage scenarios of the 5G communication network may include enhanced Mobile BroadBand (eMBB), Ultra Reliable Low Latency Communication (URLLC), massive Machine Type Communication (mMTC), and the like.

The 6G communication network can support a variety of communication services and scenarios compared to the 5G communication network. The 6G communication network can meet the requirements of hyper-performance, hyper-bandwidth, hyper-space, hyper-precision, hyper-intelligence, and/or hyper-reliability. The 6G communication network can support diverse and wide frequency bands and can be applied to various usage scenarios such as terrestrial communication, non-terrestrial communication, sidelink communication, and the like.

Meanwhile, to improve sidelink communication, carrier aggregation (CA) operations, unlicensed band operations, FR2 band operations, and/or operations for coexistence between LTE and NR may be considered. In particular, methods to support sidelink communication when it is performed in an unlicensed band may be required. For operations in the unlicensed band, optimization of sidelink physical channel structures may be necessary. Furthermore, improvements in listen-before-talk (LBT) operations for sidelink communication in the unlicensed band may be required.

### SUMMARY

The present disclosure is directed to a method and an apparatus for listen-before-talk (LBT) operations in unlicensed band sidelink communication.

A method of operating a first user equipment (UE), according to a first exemplary embodiment of the present disclosure for achieving the above-described objective, may comprise: receiving, by a processor, listen-before-talk (LBT) configuration information; identifying, by the processor, an LBT period based on the LBT configuration information; performing, by the processor, an LBT operation in the LBT period; and in response to that a result of the LBT operation indicates an idle state, performing, by the processor, sidelink (SL) communication with a second UE.

The LBT configuration information may include at least one of an LBT enable/disable indicator, LBT duration information, LBT periodicity information, or LBT offset information.

The identifying of the LBT period may further comprise: selecting an LBT duration corresponding to a priority of SL data based on the LBT duration information, and a length of the LBT period is the LBT duration.

An LBT periodicity indicated by the LBT periodicity information may be configured to be associated with a physical sidelink feedback channel (PSFCH) periodicity.

An LBT periodicity indicated by the LBT periodicity information may be set to be shorter as the priority of the SL data is higher, and the LBT periodicity may be set to be longer as the priority of the SL data is lower.

The LBT configuration information may be received through at least one of higher layer signaling, medium access control (MAC) signaling, or physical (PHY) signaling of the base station.

The LBT period may be configured in a portion of or an entire PSFCH symbol within a slot, a portion of or an entire symbol before the PSFCH symbol, a portion of or an entire symbol after the PSFCH symbol, a portion of or an entire Tx/Rx switching symbol, a portion of or an entire symbol before the Tx/Rx switching symbol, or a portion of or an entire symbol after the Tx/Rx switching symbol.

The performing of the SL communication with the second UE may comprise: transmitting SL data to the second UE in an unlicensed band, and sidelink control information (SCI) including scheduling information of the SL data may be transmitted to the second UE in a licensed band or the unlicensed band.

When the SCI is transmitted in the unlicensed band, the LBT operation may be divided into a first LBT operation for transmission of the SCI and a second LBT operation for transmission of the SL data.

The performing of the SL communication with the second UE may comprise: transmitting SCI to the second UE within a channel occupancy time (COT) of an unlicensed band, and SL data scheduled by the SCI may be transmitted to the second UE within the COT without performing the LBT operation.

A first user equipment (UE), according to a second exemplary embodiment of the present disclosure for achieving the above-described objective, may comprise: a processor, and the processor may cause the first UE to perform: receiving listen-before-talk (LBT) configuration information; identifying an LBT period based on the LBT configuration information; performing an LBT operation in the LBT period; and in response to that a result of the LBT operation indicates an idle state, performing sidelink (SL) communication with the second UE.

The LBT configuration information may include at least one of an LBT enable/disable indicator, LBT duration information, LBT periodicity information, or LBT offset information.

In the identifying of the LBT period, the processor may cause the first UE to perform: selecting an LBT duration corresponding to a priority of SL data based on the LBT duration information, and a length of the LBT period is the LBT duration.

An LBT periodicity indicated by the LBT periodicity information may be configured to be associated with a physical sidelink feedback channel (PSFCH) periodicity.

An LBT periodicity indicated by the LBT periodicity information may be set to be shorter as the priority of the SL data is higher, and the LBT periodicity may be set to be longer as the priority of the SL data is lower.

The LBT configuration information may be received through at least one of higher layer signaling, medium access control (MAC) signaling, or physical (PHY) signaling of the base station.

The LBT period may be configured in a portion of or an entire PSFCH symbol within a slot, a portion of or an entire symbol before the PSFCH symbol, a portion of or an entire symbol after the PSFCH symbol, a portion of or an entire Tx/Rx switching symbol, a portion of or an entire symbol before the Tx/Rx switching symbol, or a portion of or an entire symbol after the Tx/Rx switching symbol.

In the performing of the SL communication with the second UE, the processor may cause the first UE to perform: transmitting SL data to the second UE in an unlicensed band, and sidelink control information (SCI) including scheduling information of the SL data may be transmitted to the second UE in a licensed band or the unlicensed band.

When the SCI is transmitted in the unlicensed band, the LBT operation may be divided into a first LBT operation for transmission of the SCI and a second LBT operation for transmission of the SL data.

In the performing of the SL communication with the second UE, the processor may cause the first UE to perform: transmitting SCI to the second UE within a channel occupancy time (COT) of an unlicensed band, and SL data scheduled by the SCI may be transmitted to the second UE within the COT without performing the LBT operation.

According to the present disclosure, a first user equipment (UE) can receive LBT configuration information, perform an LBT operation based on the LBT configuration information, and transmit SL data to a second UE when the LBT operation is successful. According to the above-described operation, SL communication between UEs in an unlicensed band can be performed. An LBT period during which the LBT operation is performed may be configured in a portion of or an entire specific symbol within a slot (e.g., SL slot). Accordingly, the efficiency of resource usage can be improved, and the performance of the communication system can be enhanced.

### BRIEF DESCRIPTION OF THE DRAWINGS

FIG. 1 is a conceptual diagram illustrating scenarios of Vehicle-to-Everything (V2X) communications.

FIG. 2 is a conceptual diagram illustrating a first exemplary embodiment of a communication system.

FIG. 3 is a conceptual diagram illustrating a first exemplary embodiment of a communication node constituting a communication system.

FIG. 4 is a block diagram illustrating a first exemplary embodiment of communication nodes performing communication.

FIG. 5A is a block diagram illustrating a first exemplary embodiment of a transmission path.

FIG. 5B is a block diagram illustrating a first exemplary embodiment of a reception path.

FIG. 6 is a block diagram illustrating a first exemplary embodiment of a user plane protocol stack of a UE performing sidelink communication.

FIG. 7 is a block diagram illustrating a first exemplary embodiment of a control plane protocol stack of a UE performing sidelink communication.

FIG. 8 is a block diagram illustrating a second exemplary embodiment of a control plane protocol stack of a UE performing sidelink communication.

FIG. 9 is a timing diagram illustrating a first exemplary embodiment of a communication method in an unlicensed band.

FIG. 10 is a conceptual diagram illustrating a first exemplary embodiment of an LBT operation in SL-U communication.

FIG. 11 is a conceptual diagram illustrating a second exemplary embodiment of an LBT operation in SL-U communication.

FIG. 12 is a conceptual diagram illustrating a first exemplary embodiment of a slot including an LBT period.

FIG. 13 is a conceptual diagram illustrating a second exemplary embodiment of a slot including an LBT period.

FIG. 14 is a conceptual diagram illustrating a third exemplary embodiment of a slot including an LBT period.

FIG. 15 is a conceptual diagram illustrating a fourth exemplary embodiment of a slot including an LBT period.

FIG. 16 is a conceptual diagram illustrating a fifth exemplary embodiment of a slot including an LBT period.

FIG. 17 is a conceptual diagram illustrating a first exemplary embodiment of a slot including an LBT period and/or PSFCH symbol.

FIG. 18 is a sequence chart illustrating a first exemplary embodiment of a SL-U communication method.

### DETAILED DESCRIPTION

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

In the present disclosure, ‘(re) transmission’ may refer to ‘transmission’, ‘retransmission’, or ‘transmission and retransmission’, ‘(re) configuration’ may refer to ‘configuration’, ‘reconfiguration’, or ‘configuration and reconfiguration’, ‘(re) connection’ may refer to ‘connection’, ‘reconnection’, or ‘connection and reconnection’, and ‘(re) access’ may refer to ‘access’, ‘re-access’, or ‘access and re-access’.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Hereinafter, exemplary embodiments of the present disclosure will be described in detail with reference to the accompanying drawings. In describing the disclosure, to facilitate the entire understanding of the disclosure, like numbers refer to like elements throughout the description of the figures and the repetitive description thereof will be omitted. The operations according to the exemplary embodiments described explicitly in the present disclosure, as well as combinations of the exemplary embodiments, extensions of the exemplary embodiments, and/or variations of the exemplary embodiments, may be performed. Some operations may be omitted, and a sequence of operations may be altered.

Even when a method (e.g., transmission or reception of a signal) to be performed at a first communication node among communication nodes is described in exemplary embodiments, a corresponding second communication node may perform a method (e.g., reception or transmission of the signal) corresponding to the method performed at the first communication node. That is, when an operation of a user equipment (UE) is described, a base station corresponding thereto may perform an operation corresponding to the operation of the UE. Conversely, when an operation of a base station is described, a corresponding UE may perform an operation corresponding to the operation of the base station.

The base station may be referred to by various terms such as NodeB, evolved NodeB, next generation node B (gNodeB), gNB, device, apparatus, node, communication node, base transceiver station (BTS), radio remote head (RRH), transmission reception point (TRP), radio unit (RU), road side unit (RSU), radio transceiver, access point, access node, and the like. The user equipment (UE) may be referred to by various terms such as terminal, device, apparatus, node, communication node, end node, access terminal, mobile terminal, station, subscriber station, mobile station, portable subscriber station, on-board unit (OBU), and the like.

In the present disclosure, signaling may be one or a combination of two or more of higher layer signaling, MAC signaling, and physical (PHY) signaling. A message used for higher layer signaling may be referred to as a ‘higher layer message’ or ‘higher layer signaling message’. A message used for MAC signaling may be referred to as a ‘MAC message’ or ‘MAC signaling message’. A message used for PHY signaling may be referred to as a ‘PHY message’ or ‘PHY signaling message’. The higher layer signaling may refer to an operation of transmitting and receiving system information (e.g., master information block (MIB), system information block (SIB)) and/or an RRC message. The MAC signaling may refer to an operation of transmitting and receiving a MAC control element (CE). The PHY signaling may refer to an operation of transmitting and receiving control information (e.g., downlink control information (DCI), uplink control information (UCI), or sidelink control information (SCI)).

In the present disclosure, ‘configuration of an operation (e.g., transmission operation)’ may refer to signaling of configuration information (e.g., information elements, parameters) required for the operation and/or information indicating to perform the operation. ‘configuration of information elements (e.g., parameters)’ may refer to signaling of the information elements. In the present disclosure, ‘signal and/or channel’ may refer to signal, channel, or both signal and channel, and ‘signal’ may be used to mean ‘signal and/or channel’.

A communication network to which exemplary embodiments are applied is not limited to that described below, and the exemplary embodiments may be applied to various communication networks (e.g., 4G communication networks, 5G communication networks, and/or 6G communication networks). Here, ‘communication network’ may be used interchangeably with a term ‘communication system’.

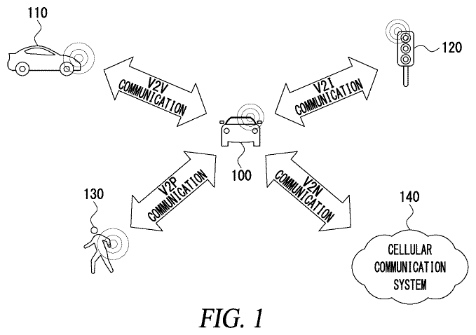

FIG. 1 is a conceptual diagram illustrating scenarios of Vehicle-to-Everything (V2X) communications.

As shown in FIG. 1, V2X communications may include Vehicle-to-Vehicle (V2V) communications, Vehicle-to-Infrastructure (V2I) communications, Vehicle-to-Pedestrian (V2P) communications, Vehicle-to-Network (V2N) communications, and the like. The V2X communications may be supported by a communication system (e.g., communication network) 140, and the V2X communications supported by the communication system 140 may be referred to as ‘Cellular-V2X (C-V2X) communications’. Here, the communication system 140 may include the 4G communication system (e.g., LTE communication system or LTE-A communication system), 5G communication system (e.g., NR communication system), and the like.

The V2V communications may include communications between a first vehicle 100 (e.g., a communication node located in the vehicle 100) and a second vehicle 110 (e.g., a communication node located in the vehicle 110). Various driving information such as velocity, heading, time, position, and the like may be exchanged between the vehicles 100 and 110 through the V2V communications. For example, autonomous driving (e.g., platooning) may be supported based on the driving information exchanged through the V2V communications. The V2V communications supported by the communication system 140 may be performed based on sidelink communication technologies (e.g., Proximity Based Services (ProSe) and Device-to-Device (D2D) communication technologies, and the like). In this case, the communications between the vehicles 100 and 110 may be performed using at least one sidelink channel.

The V2I communications may include communications between the first vehicle 100 and an infrastructure (e.g., road side unit (RSU)) 120 located on a roadside. The infrastructure 120 may include a traffic light or a street light which is located on the roadside. For example, when the V2I communications are performed, the communications may be performed between the communication node located in the first vehicle 100 and a communication node located in a traffic light. Traffic information, driving information, and the like may be exchanged between the first vehicle 100 and the infrastructure 120 through the V2I communications. The V2I communications supported by the communication system 140 may be performed based on sidelink communication technologies (e.g., ProSe and D2D communication technologies, and the like). In this case, the communications between the vehicle 100 and the infrastructure 120 may be performed using at least one sidelink channel.

The V2P communications may include communications between the first vehicle 100 (e.g., the communication node located in the vehicle 100) and a person 130 (e.g., a communication node carried by the person 130). The driving information of the first vehicle 100 and movement information of the person 130 such as velocity, heading, time, position, and the like may be exchanged between the vehicle 100 and the person 130 through the V2P communications. The communication node located in the vehicle 100 or the communication node carried by the person 130 may generate an alarm indicating a danger by judging a dangerous situation based on the obtained driving information and movement information. The V2P communications supported by the communication system 140 may be performed based on sidelink communication technologies (e.g., ProSe and D2D communication technologies, and the like). In this case, the communications between the communication node located in the vehicle 100 and the communication node carried by the person 130 may be performed using at least one sidelink channel.

The V2N communications may be communications between the first vehicle 100 (e.g., the communication node located in the vehicle 100) and the communication system (e.g., communication network) 140. The V2N communications may be performed based on the 4G communication technology (e.g., LTE or LTE-A specified as the 3GPP standards) or the 5G communication technology (e.g., NR specified as the 3GPP standards). Also, the V2N communications may be performed based on a Wireless Access in Vehicular Environments (WAVE) communication technology or a Wireless Local Area Network (WLAN) communication technology which is defined in Institute of Electrical and Electronics Engineers (IEEE) 802.11, a Wireless Personal Area Network (WPAN) communication technology defined in IEEE 802.15, or the like.

Meanwhile, the communication system 140 supporting the V2X communications may be configured as follows.

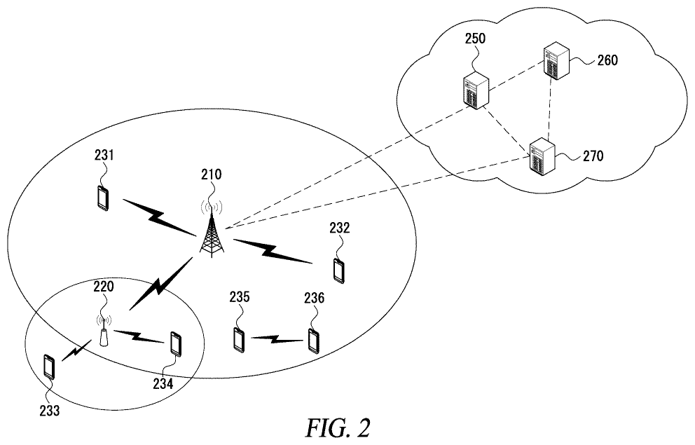

FIG. 2 is a conceptual diagram illustrating a first exemplary embodiment of a communication system.

As shown in FIG. 2, a communication system may include an access network, a core network, and the like. The access network may include a base station 210, a relay 220, user equipment (UEs) 231 through 236, and the like. The UEs 231 through 236 may include communication nodes located in the vehicles 100 and 110 of FIG. 1, the communication node located in the infrastructure 120 of FIG. 1, the communication node carried by the person 130 of FIG. 1, and the like. When the communication system supports the 4G communication technology, the core network may include a serving gateway (S-GW) 250, a packet data network (PDN) gateway (P-GW) 260, a mobility management entity (MME) 270, and the like.

When the communication system supports the 5G communication technology, the core network may include a user plane function (UPF) 250, a session management function (SMF) 260, an access and mobility management function (AMF) 270, and the like. Alternatively, when the communication system operates in a Non-Stand Alone (NSA) mode, the core network constituted by the S-GW 250, the P-GW 260, and the MME 270 may support the 5G communication technology as well as the 4G communication technology, and the core network constituted by the UPF 250, the SMF 260, and the AMF 270 may support the 4G communication technology as well as the 5G communication technology.

In addition, when the communication system supports a network slicing technique, the core network may be divided into a plurality of logical network slices. For example, a network slice supporting V2X communications (e.g., a V2V network slice, a V2I network slice, a V2P network slice, a V2N network slice, etc.) may be configured, and the V2X communications may be supported through the V2X network slices configured in the core network.

The communication nodes (e.g., base station, relay, UE, S-GW, P-GW, MME, UPF, SMF, AMF, etc.) constituting the communication system may perform communications by using at least one communication technology among a code division multiple access (CDMA) technology, a time division multiple access (TDMA) technology, a frequency division multiple access (FDMA) technology, an orthogonal frequency division multiplexing (OFDM) technology, a filtered OFDM technology, an orthogonal frequency division multiple access (OFDMA) technology, a single carrier FDMA (SC-FDMA) technology, a non-orthogonal multiple access (NOMA) technology, a generalized frequency division multiplexing (GFDM) technology, a filter bank multi-carrier (FBMC) technology, a universal filtered multi-carrier (UFMC) technology, and a space division multiple access (SDMA) technology.

The communication nodes (e.g., base station, relay, UE, S-GW, P-GW, MME, UPF, SMF, AMF, etc.) constituting the communication system may be configured as follows.

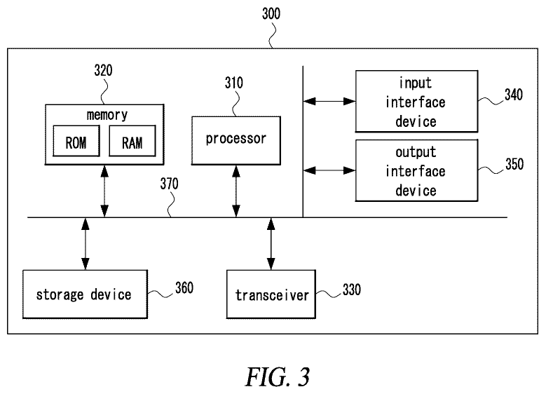

FIG. 3 is a conceptual diagram illustrating a first exemplary embodiment of a communication node constituting a communication system.

As shown in FIG. 3, a communication node 300 may comprise at least one processor 310, a memory 320, and a transceiver 330 connected to a network for performing communications. Also, the communication node 300 may further comprise an input interface device 340, an output interface device 350, a storage device 360, and the like. Each component included in the communication node 300 may communicate with each other as connected through a bus 370.

However, each of the components included in the communication node 300 may be connected to the processor 310 via a separate interface or a separate bus rather than the common bus 370. For example, the processor 310 may be connected to at least one of the memory 320, the transceiver 330, the input interface device 340, the output interface device 350, and the storage device 360 via a dedicated interface.

The processor 310 may execute at least one program command stored in at least one of the memory 320 and the storage device 360. The processor 310 may refer to a central processing unit (CPU), a graphics processing unit (GPU), or a dedicated processor on which methods in accordance with exemplary embodiments of the present disclosure are performed. Each of the memory 320 and the storage device 360 may include at least one of a volatile storage medium and a non-volatile storage medium. For example, the memory 320 may comprise at least one of read-only memory (ROM) and random access memory (RAM).

Referring again to FIG. 2, in the communication system, the base station 210 may form a macro cell or a small cell, and may be connected to the core network via an ideal backhaul or a non-ideal backhaul. The base station 210 may transmit signals received from the core network to the UEs 231 through 236 and the relay 220, and may transmit signals received from the UEs 231 through 236 and the relay 220 to the core network. The UEs 231, 232, 234, 235 and 236 may belong to a cell coverage of the base station 210. The UEs 231, 232, 234, 235 and 236 may be connected to the base station 210 by performing a connection establishment procedure with the base station 210. The UEs 231, 232, 234, 235 and 236 may communicate with the base station 210 after being connected to the base station 210.

The relay 220 may be connected to the base station 210 and may relay communications between the base station 210 and the UEs 233 and 234. That is, the relay 220 may transmit signals received from the base station 210 to the UEs 233 and 234, and may transmit signals received from the UEs 233 and 234 to the base station 210. The UE 234 may belong to both of the cell coverage of the base station 210 and the cell coverage of the relay 220, and the UE 233 may belong to the cell coverage of the relay 220. That is, the UE 233 may be located outside the cell coverage of the base station 210. The UEs 233 and 234 may be connected to the relay 220 by performing a connection establishment procedure with the relay 220. The UEs 233 and 234 may communicate with the relay 220 after being connected to the relay 220.

The base station 210 and the relay 220 may support multiple-input multiple-output (MIMO) technologies (e.g., single user (SU)-MIMO, multi-user (MU)-MIMO, massive MIMO, etc.), coordinated multipoint (COMP) communication technologies, carrier aggregation (CA) communication technologies, unlicensed band communication technologies (e.g., Licensed Assisted Access (LAA), enhanced LAA (eLAA), etc.), sidelink communication technologies (e.g., ProSe communication technology, D2D communication technology), or the like. The UEs 231, 232, 235 and 236 may perform operations corresponding to the base station 210 and operations supported by the base station 210. The UEs 233 and 234 may perform operations corresponding to the relays 220 and operations supported by the relays 220.

Here, the base station 210 may be referred to as a Node B (NB), evolved Node B (eNB), base transceiver station (BTS), radio remote head (RRH), transmission reception point (TRP), radio unit (RU), roadside unit (RSU), radio transceiver, access point, access node, or the like. The relay 220 may be referred to as a small base station, relay node, or the like. Each of the UEs 231 through 236 may be referred to as a terminal, access terminal, mobile terminal, station, subscriber station, mobile station, portable subscriber station, node, device, on-broad unit (OBU), or the like.

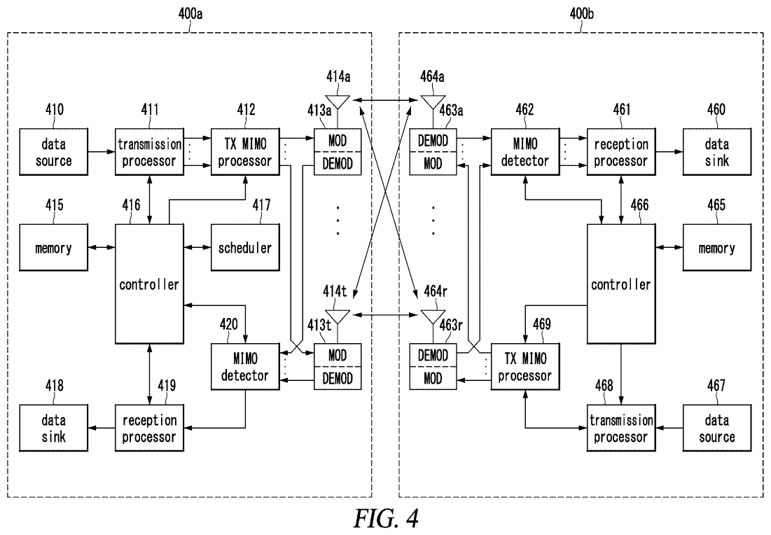

Meanwhile, communication nodes that perform communications in the communication network may be configured as follows. A communication node shown in FIG. 4 may be a specific exemplary embodiment of the communication node shown in FIG. 3.

FIG. 4 is a block diagram illustrating a first exemplary embodiment of communication nodes performing communication.

As shown in FIG. 4, each of a first communication node 400a and a second communication node 400b may be a base station or UE. The first communication node 400a may transmit a signal to the second communication node 400b. A transmission processor 411 included in the first communication node 400a may receive data (e.g., data unit) from a data source 410. The transmission processor 411 may receive control information from a controller 416. The control information may include at least one of system information, RRC configuration information (e.g., information configured by RRC signaling), MAC control information (e.g., MAC CE), or PHY control information (e.g., DCI, SCI).

The transmission processor 411 may generate data symbol(s) by performing processing operations (e.g., encoding operation, symbol mapping operation, etc.) on the data. The transmission processor 411 may generate control symbol(s) by performing processing operations (e.g., encoding operation, symbol mapping operation, etc.) on the control information. In addition, the transmission processor 411 may generate synchronization/reference symbol(s) for synchronization signals and/or reference signals.

A Tx MIMO processor 412 may perform spatial processing operations (e.g., precoding operations) on the data symbol(s), control symbol(s), and/or synchronization/reference symbol(s). An output (e.g., symbol stream) of the Tx MIMO processor 412 may be provided to modulators (MODs) included in transceivers 413a to 413t. The modulator may generate modulation symbols by performing processing operations on the symbol stream, and may generate signals by performing additional processing operations (e.g., analog conversion operations, amplification operation, filtering operation, up-conversion operation, etc.) on the modulation symbols. The signals generated by the modulators of the transceivers 413a to 413t may be transmitted through antennas 414a to 414t.

The signals transmitted by the first communication node 400a may be received at antennas 464a to 464r of the second communication node 400b. The signals received at the antennas 464a to 464r may be provided to demodulators (DEMODs) included in transceivers 463a to 463r. The demodulator (DEMOD) may obtain samples by performing processing operations (e.g., filtering operation, amplification operation, down-conversion operation, digital conversion operation, etc.) on the signals. The demodulator may perform additional processing operations on the samples to obtain symbols. A MIMO detector 462 may perform MIMO detection operations on the symbols. A reception processor 461 may perform processing operations (e.g., de-interleaving operation, decoding operation, etc.) on the symbols. An output of the reception processor 461 may be provided to a data sink 460 and a controller 466. For example, the data may be provided to the data sink 460 and the control information may be provided to the controller 466.

On the other hand, the second communication node 400b may transmit signals to the first communication node 400a. A transmission processor 469 included in the second communication node 400b may receive data (e.g., data unit) from a data source 467 and perform processing operations on the data to generate data symbol(s). The transmission processor 468 may receive control information from the controller 466 and perform processing operations on the control information to generate control symbol(s). In addition, the transmission processor 468 may generate reference symbol(s) by performing processing operations on reference signals.

A Tx MIMO processor 469 may perform spatial processing operations (e.g., precoding operations) on the data symbol(s), control symbol(s), and/or reference symbol(s). An output (e.g., symbol stream) of the Tx MIMO processor 469 may be provided to modulators (MODs) included in the transceivers 463a to 463t. The modulator may generate modulation symbols by performing processing operations on the symbol stream, and may generate signals by performing additional processing operations (e.g., analog conversion operation, amplification operation, filtering operation, up-conversion operations) on the modulation symbols. The signals generated by the modulators of the transceivers 463a to 463t may be transmitted through the antennas 464a to 464t.

The signals transmitted by the second communication node 400b may be received at the antennas 414a to 414r of the first communication node 400a. The signals received at the antennas 414a to 414r may be provided to demodulators (DEMODs) included in the transceivers 413a to 413r. The demodulator may obtain samples by performing processing operations (e.g., filtering operation, amplification operation, down-conversion operation, digital conversion operation) on the signals. The demodulator may perform additional processing operations on the samples to obtain symbols. A MIMO detector 420 may perform a MIMO detection operation on the symbols. The reception processor 419 may perform processing operations (e.g., de-interleaving operation, decoding operation, etc.) on the symbols. An output of the reception processor 419 may be provided to a data sink 418 and the controller 416. For example, the data may be provided to the data sink 418 and the control information may be provided to the controller 416.

Memories 415 and 465 may store the data, control information, and/or program codes. A scheduler 417 may perform scheduling operations for communication. The processors 411, 412, 419, 461, 468, and 469 and the controllers 416 and 466 shown in FIG. 4 may be the processor 310 shown in FIG. 3, and may be used to perform methods described in the present disclosure.

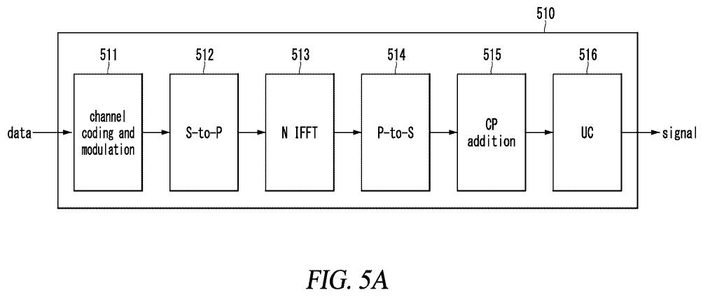

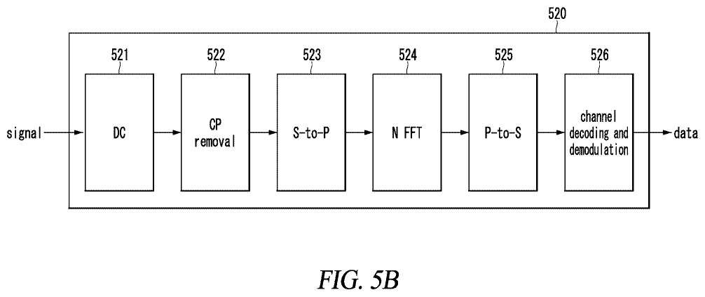

FIG. 5A is a block diagram illustrating a first exemplary embodiment of a transmission path, and FIG. 5B is a block diagram illustrating a first exemplary embodiment of a reception path.

As shown in FIGS. 5A and 5B, a transmission path 510 may be implemented in a communication node that transmits signals, and a reception path 520 may be implemented in a communication node that receives signals. The transmission path 510 may include a channel coding and modulation block 511, a serial-to-parallel (S-to-P) block 512, an N-point inverse fast Fourier transform (N-point IFFT) block 513, a parallel-to-serial (P-to-S) block 514, a cyclic prefix (CP) addition block 515, and up-converter (UC) 516. The reception path 520 may include a down-converter (DC) 521, a CP removal block 522, an S-to-P block 523, an N-point FFT block 524, a P-to-S block 525, and a channel decoding and demodulation block 526. Here, N may be a natural number.

In the transmission path 510, information bits may be input to the channel coding and modulation block 511. The channel coding and modulation block 511 may perform a coding operation (e.g., low-density parity check (LDPC) coding operation, polar coding operation, etc.) and a modulation operation (e.g., Quadrature Phase Shift Keying (OPSK), Quadrature Amplitude Modulation (QAM), etc.) on the information bits. An output of the channel coding and modulation block 511 may be a sequence of modulation symbols.

The S-to-P block 512 may convert frequency domain modulation symbols into parallel symbol streams to generate N parallel symbol streams. N may be the IFFT size or the FFT size. The N-point IFFT block 513 may generate time domain signals by performing an IFFT operation on the N parallel symbol streams. The P-to-S block 514 may convert the output (e.g., parallel signals) of the N-point IFFT block 513 to serial signals to generate the serial signals.

The CP addition block 515 may insert a CP into the signals. The UC 516 may up-convert a frequency of the output of the CP addition block 515 to a radio frequency (RF) frequency. Further, the output of the CP addition block 515 may be filtered in baseband before the up-conversion.

The signal transmitted from the transmission path 510 may be input to the reception path 520. Operations in the reception path 520 may be reverse operations for the operations in the transmission path 510. The DC 521 may down-convert a frequency of the received signals to a baseband frequency. The CP removal block 522 may remove a CP from the signals. The output of the CP removal block 522 may be serial signals. The S-to-P block 523 may convert the serial signals into parallel signals. The N-point FFT block 524 may generate N parallel signals by performing an FFT algorithm. The P-to-S block 525 may convert the parallel signals into a sequence of modulation symbols. The channel decoding and demodulation block 526 may perform a demodulation operation on the modulation symbols and may restore data by performing a decoding operation on a result of the demodulation operation.

In FIGS. 5A and 5B, discrete Fourier transform (DFT) and inverse DFT (IDFT) may be used instead of FFT and IFFT. Each of the blocks (e.g., components) in FIGS. 5A and 5B may be implemented by at least one of hardware, software, or firmware. For example, some blocks in FIGS. 5A and 5B may be implemented by software, and other blocks may be implemented by hardware or a combination of hardware and software. In FIGS. 5A and 5B, one block may be subdivided into a plurality of blocks, a plurality of blocks may be integrated into one block, some blocks may be omitted, and blocks supporting other functions may be added.

Meanwhile, communications between the UEs 235 and 236 may be performed based on sidelink communication technology (e.g., ProSe communication technology, D2D communication technology). The sidelink communication may be performed based on a one-to-one scheme or a one-to-many scheme. When V2V communication is performed using sidelink communication technology, the UE 235 may refer to a communication node located in the first vehicle 100 of FIG. 1, and the UE 236 may refer to a communication node located in the second vehicle 110 of FIG. 1. When V2I communication is performed using sidelink communication technology, the UE 235 may refer to a communication node located in the first vehicle 100 of FIG. 1, and the UE 236 may refer to a communication node located in the infrastructure 120 of FIG. 1. When V2P communication is performed using sidelink communication technology, the UE 235 may refer to a communication node located in the first vehicle 100 of FIG. 1, and the UE 236 may refer to a communication node carried by the person 130.

The scenarios to which the sidelink communications are applied may be classified as shown below in Table 1 according to the positions of the UEs (e.g., the UEs 235 and 236) participating in the sidelink communications. For example, the scenario for the sidelink communications between the UEs 235 and 236 shown in FIG. 2 may be a sidelink communication scenario C.

TABLE 1

| Sidelink | | |
|---|---|---|
| Communication | | |
| Scenario | Position of UE 235 | Position of UE 236 |
| A | Out of coverage of base | Out of coverage of base |
| | station 210 | station 210 |
| B | In coverage of base | Out of coverage of base |
| | station 210 | station 210 |
| C | In coverage of base | In coverage of base |
| | station 210 | station 210 |
| D | In coverage of base | In coverage of other base |
| | station 210 | station |

Meanwhile, a user plane protocol stack of the UEs (e.g., the UEs 235 and 236) performing sidelink communications may be configured as follows.

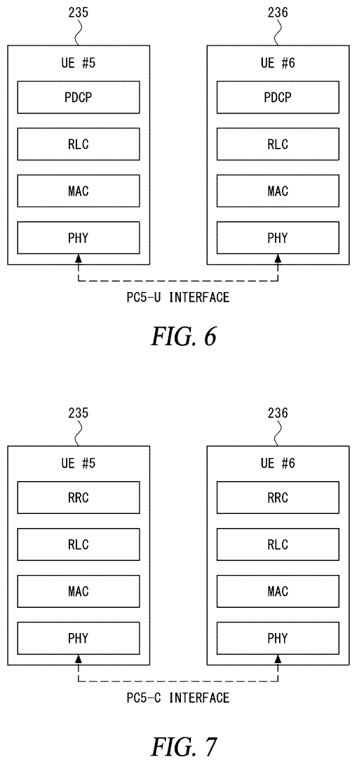

FIG. 6 is a block diagram illustrating a first exemplary embodiment of a user plane protocol stack of a UE performing sidelink communication.

As shown in FIG. 6, the UE 235 may be the UE 235 shown in FIG. 2 and the UE 236 may be the UE 236 shown in FIG. 2. The scenario for the sidelink communications between the UEs 235 and 236 may be one of the sidelink communication scenarios A to D of Table 1. The user plane protocol stack of each of the UEs 235 and 236 may comprise a physical (PHY) layer, a medium access control (MAC) layer, a radio link control (RLC) layer, and a packet data convergence protocol (PDCP) layer.

The sidelink communications between the UEs 235 and 236 may be performed using a PC5 interface (e.g., PC5-U interface). A layer-2 identifier (ID) (e.g., a source layer-2 ID, a destination layer-2 ID) may be used for the sidelink communications, and the layer 2-ID may be an ID configured for the V2X communications. Also, in the sidelink communications, a hybrid automatic repeat request (HARQ) feedback operation may be supported, and an RLC acknowledged mode (RLC AM) or an RLC unacknowledged mode (RLC UM) may be supported.

Meanwhile, a control plane protocol stack of the UEs (e.g., the UEs 235 and 236) performing sidelink communications may be configured as follows.

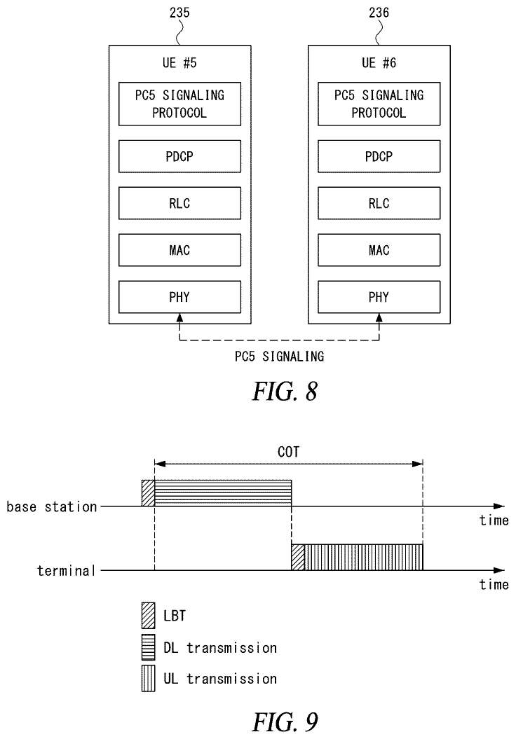

FIG. 7 is a block diagram illustrating a first exemplary embodiment of a control plane protocol stack of a UE performing sidelink communication, and FIG. 8 is a block diagram illustrating a second exemplary embodiment of a control plane protocol stack of a UE performing sidelink communication.

As shown in FIGS. 7 and 8, the UE 235 may be the UE 235 shown in FIG. 2 and the UE 236 may be the UE 236 shown in FIG. 2. The scenario for the sidelink communications between the UEs 235 and 236 may be one of the sidelink communication scenarios A to D of Table 1. The control plane protocol stack illustrated in FIG. 7 may be a control plane protocol stack for transmission and reception of broadcast information (e.g., Physical Sidelink Broadcast Channel (PSBCH)).

The control plane protocol stack shown in FIG. 7 may include a PHY layer, a MAC layer, an RLC layer, and a radio resource control (RRC) layer. The sidelink communications between the UEs 235 and 236 may be performed using a PC5 interface (e.g., PC5-C interface). The control plane protocol stack shown in FIG. 8 may be a control plane protocol stack for one-to-one sidelink communication. The control plane protocol stack shown in FIG. 8 may include a PHY layer, a MAC layer, an RLC layer, a PDCP layer, and a PC5 signaling protocol layer.

Meanwhile, channels used in the sidelink communications between the UEs 235 and 236 may include a Physical Sidelink Shared Channel (PSSCH), a Physical Sidelink Control Channel (PSCCH), a Physical Sidelink Discovery Channel (PSDCH), and a Physical Sidelink Broadcast Channel (PSBCH). The PSSCH may be used for transmitting and receiving sidelink data and may be configured in the UE (e.g., UE 235 or 236) by higher layer signaling. The PSCCH may be used for transmitting and receiving sidelink control information (SCI) and may also be configured in the UE (e.g., UE 235 or 236) by higher layer signaling.

The PSDCH may be used for a discovery procedure. For example, a discovery signal may be transmitted over the PSDCH. The PSBCH may be used for transmitting and receiving broadcast information (e.g., system information). Also, a demodulation reference signal (DM-RS), a synchronization signal, or the like may be used in the sidelink communications between the UEs 235 and 236. The synchronization signal may include a primary sidelink synchronization signal (PSSS) and a secondary sidelink synchronization signal (SSSS).

Meanwhile, a sidelink transmission mode (TM) may be classified into sidelink TMs 1 to 4 as shown below in Table 2.

TABLE 2

| Sidelink | |
|---|---|
| TM | Description |
| 1 | Transmission using resources scheduled by base station |
| 2 | UE autonomous transmission without scheduling of base station |
| 3 | Transmission using resources scheduled by base station in V2X |
| | communications |
| 4 | UE autonomous transmission without scheduling of base station |
| | in V2X communications |

When the sidelink TM 3 or 4 is supported, each of the UEs 235 and 236 may perform sidelink communications using a resource pool configured by the base station 210. The resource pool may be configured for each of the sidelink control information and the sidelink data.

The resource pool for the sidelink control information may be configured based on an RRC signaling procedure (e.g., a dedicated RRC signaling procedure, a broadcast RRC signaling procedure). The resource pool used for reception of the sidelink control information may be configured by a broadcast RRC signaling procedure. When the sidelink TM 3 is supported, the resource pool used for transmission of the sidelink control information may be configured by a dedicated RRC signaling procedure. In this case, the sidelink control information may be transmitted through resources scheduled by the base station 210 within the resource pool configured by the dedicated RRC signaling procedure. When the sidelink TM 4 is supported, the resource pool used for transmission of the sidelink control information may be configured by a dedicated RRC signaling procedure or a broadcast RRC signaling procedure. In this case, the sidelink control information may be transmitted through resources selected autonomously by the UE (e.g., UE 235 or 236) within the resource pool configured by the dedicated RRC signaling procedure or the broadcast RRC signaling procedure.

When the sidelink TM 3 is supported, the resource pool for transmitting and receiving sidelink data may not be configured. In this case, the sidelink data may be transmitted and received through resources scheduled by the base station 210. When the sidelink TM 4 is supported, the resource pool for transmitting and receiving sidelink data may be configured by a dedicated RRC signaling procedure or a broadcast RRC signaling procedure. In this case, the sidelink data may be transmitted and received through resources selected autonomously by the UE (e.g., UE 235 or 236) within the resource pool configured by the dedicated RRC signaling procedure or the broadcast RRC signaling procedure.

Hereinafter, sidelink communication methods will be described. Even when a method (e.g., transmission or reception of a signal) to be performed at a first communication node among communication nodes is described, a corresponding second communication node may perform a method (e.g., reception or transmission of the signal) corresponding to the method performed at the first communication node. That is, when an operation of a UE #1 (e.g., vehicle #1) is described, a UE #2 (e.g., vehicle #2) corresponding thereto may perform an operation corresponding to the operation of the UE #1. Conversely, when an operation of the UE #2 is described, the corresponding UE #1 may perform an operation corresponding to the operation of the UE #2. In exemplary embodiments described below, an operation of a vehicle may be an operation of a communication node located in the vehicle.

A sidelink signal may be a synchronization signal and a reference signal used for sidelink communication. For example, the synchronization signal may be a synchronization signal/physical broadcast channel (SS/PBCH) block, sidelink synchronization signal (SLSS), primary sidelink synchronization signal (PSSS), secondary sidelink synchronization signal (SSSS), or the like. The reference signal may be a channel state information-reference signal (CSI-RS), DM-RS, phase tracking-reference signal (PT-RS), cell-specific reference signal (CRS), sounding reference signal (SRS), discovery reference signal (DRS), or the like.

A sidelink channel may be a PSSCH, PSCCH, PSDCH, PSBCH, physical sidelink feedback channel (PSFCH), or the like. In addition, a sidelink channel may refer to a sidelink channel including a sidelink signal mapped to specific resources in the corresponding sidelink channel. The sidelink communication may support a broadcast service, a multicast service, a groupcast service, and a unicast service.

The base station may transmit system information (e.g., SIB12, SIB13, SIB14) and RRC messages including configuration information for sidelink communication (i.e., sidelink configuration information) to UE(s). The UE may receive the system information and RRC messages from the base station, identify the sidelink configuration information included in the system information and RRC messages, and perform sidelink communication based on the sidelink configuration information. The SIB12 may include sidelink communication/discovery configuration information. The SIB13 and SIB14 may include configuration information for V2X sidelink communication.

The sidelink communication may be performed within a SL bandwidth part (BWP). The base station may configure SL BWP(s) to the UE using higher layer signaling. The higher layer signaling may include SL-BWP-Config and/or SL-BWP-ConfigCommon. SL-BWP-Config may be used to configure a SL BWP for UE-specific sidelink communication. SL-BWP-ConfigCommon may be used to configure cell-specific configuration information.

Furthermore, the base station may configure resource pool(s) to the UE using higher layer signaling. The higher layer signaling may include SL-BWP-PoolConfig, SL-BWP-PoolConfigCommon, SL-BWP-DiscPoolConfig, and/or SL-BWP-DiscPoolConfigCommon. SL-BWP-PoolConfig may be used to configure a sidelink communication resource pool. SL-BWP-PoolConfigCommon may be used to configure a cell-specific sidelink communication resource pool. SL-BWP-DiscPoolConfig may be used to configure a resource pool dedicated to UE-specific sidelink discovery. SL-BWP-DiscPoolConfigCommon may be used to configure a resource pool dedicated to cell-specific sidelink discovery. The UE may perform sidelink communication within the resource pool configured by the base station.

The sidelink communication may support SL discontinuous reception (DRX) operations. The base station may transmit a higher layer message (e.g., SL-DRX-Config) including SL DRX-related parameter(s) to the UE. The UE may perform SL DRX operations based on SL-DRX-Config received from the base station. The sidelink communication may support inter-UE coordination operations. The base station may transmit a higher layer message (e.g., SL-InterUE-CoordinationConfig) including inter-UE coordination parameter(s) to the UE. The UE may perform inter-UE coordination operations based on SL-InterUE-CoordinationConfig received from the base station.

The sidelink communication may be performed based on a single-SCI scheme or a multi-SCI scheme. When the single-SCI scheme is used, data transmission (e.g., sidelink data transmission, sidelink-shared channel (SL-SCH) transmission) may be performed based on one SCI (e.g., 1st-stage SCI). When the multi-SCI scheme is used, data transmission may be performed using two SCIs (e.g., 1st-stage SCI and 2nd-stage SCI). The SCI(s) may be transmitted on a PSCCH and/or a PSSCH. When the single-SCI scheme is used, the SCI (e.g., 1st-stage SCI) may be transmitted on a PSCCH. When the multi-SCI scheme is used, the 1st-stage SCI may be transmitted on a PSCCH, and the 2nd-stage SCI may be transmitted on the PSCCH or a PSSCH. The 1st-stage SCI may be referred to as ‘first-stage SCI’, and the 2nd-stage SCI may be referred to as ‘second-stage SCI’. A format of the first-stage SCI may include a SCI format 1-A, and a format of the second-stage SCI may include a SCI format 2-A, a SCI format 2-B, and a SCI format 2-C.

The SCI format 1-A may be used for scheduling a PSSCH and second-stage SCI. The SCI format 1-A may include at least one among priority information, frequency resource assignment information, time resource assignment information, resource reservation period information, demodulation reference signal (DMRS) pattern information, second-stage SCI format information, beta_offset indicator, number of DMRS ports, modulation and coding scheme (MCS) information, additional MCS table indicator, PSFCH overhead indicator, or conflict information receiver flag.

The SCI format 2-A may be used for decoding of a PSSCH. The SCI format 2-A may include at least one among a HARQ processor number, new data indicator (NDI), redundancy version (RV), source ID, destination ID, HARQ feedback enable/disable indicator, cast type indicator, or CSI request.

The SCI format 2-B may be used for decoding of a PSSCH. The SCI format 2-B may include at least one among a HARQ processor number, NDI, RV, source ID, destination ID, HARQ feedback enable/disable indicator, zone ID, or communication range requirement.

The SCI format 2-C may be used for decoding of a PSSCH. In addition, the SCI format 2-C may be used to provide or request inter-UE coordination information. The SCI format 2-C may include at least one among a HARQ processor number, NDI, RV, source ID, destination ID, HARQ feedback enable/disable indicator, CSI request, or providing/requesting indicator.

When a value of the providing/requesting indicator is set to 0, this may indicate that the SCI format 2-C is used to provide inter-UE coordination information. In this case, the SCI format 2-C may include at least one among resource combinations, first resource location, reference slot location, resource set type, or lowest subchannel indexes.

When a value of the providing/requesting indicator is set to 1, this may indicate that the SCI format 2-C is used to request inter-UE coordination information. In this case, the SCI format 2-C may include at least one among a priority, number of subchannels, resource reservation period, resource selection window location, resource set type, or padding bit(s).

Meanwhile, sidelink communication may be performed in a licensed band and/or an unlicensed band. Sidelink communication performed in an unlicensed band may be referred to as sidelink-unlicensed band (SL-U) communication or unlicensed band-sidelink (U-SL) communication. In SL-U communication, a first terminal may communicate with a second terminal according to a mode 1 or mode 2. When the mode 1 is used, the first terminal may communicate with the second terminal based on scheduling by a base station. When the mode 2 is used, the first terminal may communicate with the second terminal without scheduling by a base station. The mode 1 may correspond to the sidelink TM #1 or #3 disclosed in Table 2 above. The mode 2 may correspond to the sidelink TM #2 or #4 disclosed in Table 2 above.

FIG. 9 is a timing diagram illustrating a first exemplary embodiment of a communication method in an unlicensed band.

As shown in FIG. 9, a base station may perform a listen-before-talk (LBT) operation to perform downlink (DL) transmission, and if a result of the LBT operation indicates an idle state (e.g., clean state) of a channel, the base station may perform DL transmission. A terminal may perform an LBT operation to perform uplink (UL) transmission, and if a result of the LBT operation indicates an idle state of a channel, the terminal may perform UL transmission. If the result of the LBT operation indicates a busy state of the channel, the DL transmission and/or UL transmission may not be performed. The DL transmission and/or UL transmission may be performed within a channel occupancy time (COT). The COT may be initiated by the base station or terminal. The LBT operations may be performed based on one of categories disclosed in Table 3 below.

TABLE 3

| | Description |
|---|---|
| Category 1 | The transmission operation is performed after a short |
| (Cat 1 LBT) | switching gap of 16 μs. The CCA operation is not |
| | performed. |
| Category 2 | The LBT operation is performed within a fixed CCA period |
| (Cat 2 LBT) | (e.g., 25 μs) without a random backoff operation. |
| Category 3 | The LBT operation is performed based on a random backoff |
| (Cat 3 LBT) | operation and a variable CCA period. The size of |
| | contention window is fixed. |
| Category 4 | The LBT operation is performed based on a random backoff |
| (Cat 4 LBT) | operation and a variable CCA period. The size of |
| | contention window is variable. |

The LBT operation may refer to a clear channel assessment (CCA) operation. The CCA operation may be performed during a CCA period. When the CCA operation is performed, the communication node (e.g., base station and/or terminal) may identify a channel state based on an energy detection (ED) scheme. In other words, the communication node may determine whether another signal exists in the channel. If an energy detected during the CCA period is less than a threshold (e.g., ED threshold), the communication node may determine the channel state as the idle state. In other words, the communication node may determine that no other signals exist in the channel. If the channel state is determined as the idle state, the communication node may access the channel within the COT. If the energy detected during the CCA period is equal to or above the threshold, the communication node may determine the channel state as the busy state. In other words, the communication node may determine that another signal exists in the channel. If the channel state is the busy state, the communication node may not access the channel within the COT.

In an unlicensed band, the communication node may perform the LBT operation and transmit data when a result of the LBT operation indicates the idle state of the channel. In this case, the base station may transmit a DL transmission burst within the COT, and the terminal may transmit a UL transmission burst within the COT. The COT may be configured within a maximum COT (MCOT). A slot duration of CCA may be 5 μs˜9 μs. The duration of the MCOT may be 8 ms. The base station may initiate and/or configure a COT based on a higher layer parameter SemiStaticChannelAccessConfig. SemiStaticChannelAccessConfig may include information on a period of the COT. The terminal may identify the COT initiated by the base station based on SemiStaticChannelAccessConfig.

The terminal may initiate and/or configure a COT based on a higher layer parameter SemiStaticChannelAccessConfigUE. SemiStaticChannelAccessConfigUE may include information on a period and an offset of the COT. The base station may identify the COT initiated by the terminal based on SemiStaticChannelAccessConfigUE.

The terminal may initiate and/or configure the COT based on SemiStaticChannelAccessConfigUE in the unlicensed band. As another method, the base station may signal SemiStaticChannelAccessConfigSL-U for a COT of SL-U communication to the terminal. The COT for SL-U communication may be referred to as a sidelink (SL)-COT. SemiStaticChannelAccessConfigSL-U may include information on a period and an offset of the SL-COT. The terminal may configure the SL-COT based on SemiStaticChannelAccessConfig-U. Other terminals may identify the COT initiated based on SemiStaticChannelAccessConfigSL-U.

In an unlicensed band, the terminal may perform an LBT operation before SL communication (e.g., transmission of SL data) in order to perform the SL communication. If the LBT operation succeeds, a COT may be initiated in the unlicensed band, and the SL communication may be performed within the COT. ‘The LBT operation succeeds’ may mean that a result of the LBT operation indicates an idle state.

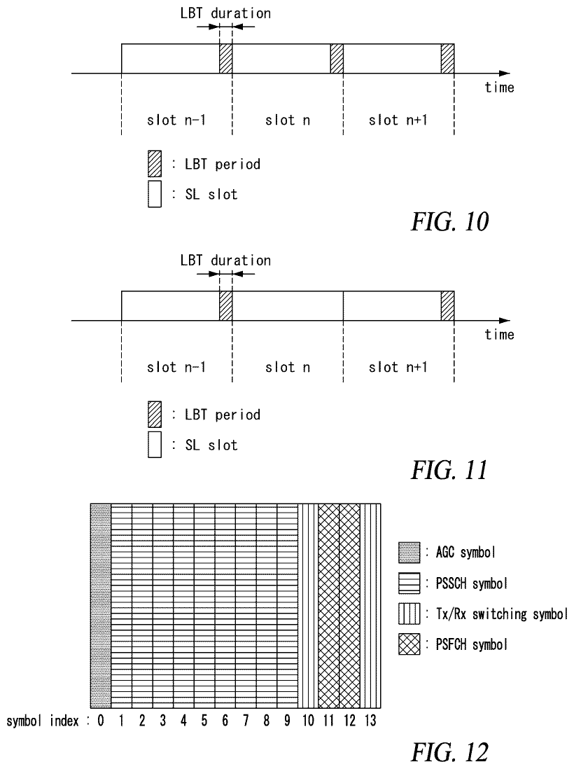

FIG. 10 is a conceptual diagram illustrating a first exemplary embodiment of an LBT operation in SL-U communication, and FIG. 11 is a conceptual diagram illustrating a second exemplary embodiment of an LBT operation in SL-U communication.

As shown FIGS. 10 and 11, in order to perform SL-U communication in a slot n, the terminal may perform an LBT operation in a slot (e.g., slot n−1) before the slot n. n may be a natural number. A period in which the LBT operation is performed may have a length of an LBT duration. Configuration information (e.g., control information) for the LBT operation may be transmitted on a control channel (e.g., PSCCH, SCI). The configuration information for the LBT operation may be referred to as LBT configuration information or LBT control information.

For example, the LBT configuration information for transmission of a data channel (e.g., PSSCH, SL data) in the slot n may be transmitted on a control channel associated with the data channel. The control channel associated with the data channel may refer to a control channel that schedules the data channel. When the LBT configuration information is included in second-stage SCI, the LBT configuration information may be transmitted on the data channel (e.g., PSSCH). Alternatively, the LBT configuration information may be signaled by a base station. In other words, the base station may transmit the LBT configuration information to terminal(s) based on at least one of higher layer signaling, MAC signaling, or PHY signaling. The control channel (e.g., SCI) may include configuration information (e.g., control information) for SL-U communication. The configuration information for SL-U communication may be referred to as SL-U configuration information or SL-U control information.

The LBT configuration information may include at least one of an LBT enable/disable indicator, LBT duration information, LBT periodicity information, or LBT offset information. When the LBT configuration information is included in the SCI, the LBT configuration information may be included in at least one of first-stage SCI or second-stage SCI. The LBT enable/disable indicator may indicate whether the LBT operation is enabled or disabled in SL communication. The LBT enable/disable indicator set to a first value may indicate that the LBT operation is enabled. The LBT enable/disable indicator set to a second value may indicate that the LBT operation is disabled.

The LBT duration information may indicate a length of an LBT period in which the LBT operation is performed. The LBT duration information (e.g., LBT duration) may be set in symbol units or time units (e.g., μs, ms). The LBT periodicity information may indicate a periodicity at which the LBT period is configured or a periodicity at which the LBT operation is performed. The LBT periodicity information (e.g., LBT periodicity) may be set in symbol units, slot units, or time units (e.g., μs, ms). The LBT offset information may indicate a start time of the LBT period. For example, when the LBT period is configured in a partial period within a specific symbol, the LBT offset information may indicate an offset between a start time of the specific symbol and a start time of the partial period. The LBT offset information (e.g., LBT offset) may be set in time units (e.g., μs, ms).

The LBT configuration information and/or SL-U configuration information may be configured in the terminal(s) through signaling. The signaling may be at least one of higher layer signaling, MAC signaling, or PHY signaling. A portion of the LBT configuration information may be configured by PHY signaling (e.g., SCI, DCI), and the remaining portion of the LBT configuration information may be configured by higher layer signaling (e.g., system information, RRC signaling). Alternatively, a plurality of values for the LBT configuration information may be configured in the terminal by higher layer signaling, and one value of the plurality of values may be indicated to the terminal by MAC signaling and/or PHY signaling.

For example, the LBT duration information may be configured as {16 μs, 25 μs, 50 μs} by higher layer signaling, and one value of 16 μs, 25 μs, and 50 μs may be indicated by MAC signaling and/or PHY signaling. The LBT periodicity information may be configured as {1 ms, 2 ms, 4 ms, 5 ms} by higher layer signaling, and one value of 1 ms, 2 ms, 4 ms, and 5 ms may be indicated by MAC signaling and/or PHY signaling. The LTE offset information may be configured as {2 μs, 5 μs, 8 μs} by higher layer signaling, and one value of 2 μs, 5 μs, and 8 μs may be indicated by MAC signaling and/or PHY signaling.

The LBT duration information may be associated with other information (e.g., priority information) included in the SCI. For example, the higher the priority, the LBT duration may increase, and the lower the priority, the LBT duration may decrease. In other words, an LBT duration associated with a higher priority may be longer than an LBT duration associated with a lower priority. The priority may mean a priority of service, a priority of terminal, and/or a priority of SL data. As the LBT duration increases, a success probability of the LBT operation (e.g., CCA operation) may increase, and accordingly, a success probability of SL data transmission in the unlicensed band may increase. In other words, a probability that the SL data transmission is allowed in the unlicensed band may increase.

The LBT duration information may be defined as in Table 4 below. In Table 4, a priority 1 may be the highest priority, and a priority 3 may be the lowest priority. The base station may signal the LBT duration information defined in Table 4 to the terminal(s). The terminal may select an LBT duration corresponding to a priority of SL data based on the LBT duration information, perform an LBT operation within the LBT duration, and transmit the SL data when the LBT operation is successful.

TABLE 4

| LBT duration | Priority |
|---|---|
| 16 μs | 3 |
| 25 μs | 2 |
| 50 μs | 1 |

The LBT periodicity may be set in slot units or time units. When the LBT periodicity is one slot, the LBT period may exist in every slot as in the exemplary embodiment of FIG. 10. When the LBT periodicity is two slots, the LBT period may exist every two slots as in the exemplary embodiment of FIG. 11. The LBT periodicity information may be associated with other information (e.g., priority information) included in the SCI. For example, the higher the priority (e.g., priority of SL data), the LBT periodicity may decrease, and the lower the priority, the LBT periodicity may increase. In other words, an LBT periodicity associated with a higher priority may be shorter than an LBT periodicity associated with a lower priority.

The LBT periodicity may be associated with a PSFCH periodicity. The LBT period may be configured within a slot including PSFCH symbol(s). The slot including PSFCH symbol(s) may be referred to as a PSFCH slot. The PSFCH periodicity may be set by sl-PSFCH-Period. The PSFCH periodicity may be set in slot units or time units. When the PSFCH periodicity is one slot, the PSFCH symbol(s) may exist in every slot. In this case, the LBT period may also exist in every slot. When the PSFCH periodicity is two slots, the PSFCH symbol(s) may exist every two slots. In this case, the LBT period may also exist every two slots. A portion of or an entire PSFCH symbol may be used as the LBT period. If the PSFCH periodicity is set in the terminal and the LBT periodicity is not, the terminal may estimate the PSFCH periodicity as the LBT periodicity. Alternatively, if the LBT periodicity is set in the terminal and the PSCFH periodicity is not, the terminal may estimate the LBT periodicity as the PSFCH periodicity.

FIG. 12 is a conceptual diagram illustrating a first exemplary embodiment of a slot including an LBT period.

As shown in FIG. 12, a slot may include 14 symbols (e.g., 14 SL symbols), and symbols 11 and 12 may be PSFCH symbols. An LBT period may be configured in a portion of or an entire PSFCH symbol (e.g., symbols 11 and/or 12). For example, the LBT period may be configured in a front half or back half of the symbol 11. Alternatively, the LBT period may be configured in a front half or back half of the symbol 12. Symbols 10 and 13 within the slot may be Tx/Rx switching symbols. The Tx/Rx switching symbol may be used for switching between a Tx operation and an Rx operation. The LBT period may be configured in a portion of or an entire Tx/Rx switching symbol (e.g., symbols 10 and/or 13). For example, the LBT period may be configured in a front half or back half of the symbol 10. Alternatively, the LBT period may be configured in a front half or back half of the symbol 13.

Alternatively, the LBT period may be configured in a portion of or an entire specific symbol(s), other than the PSFCH symbol and the Tx/Rx switching symbol, among the symbols included in the slot.

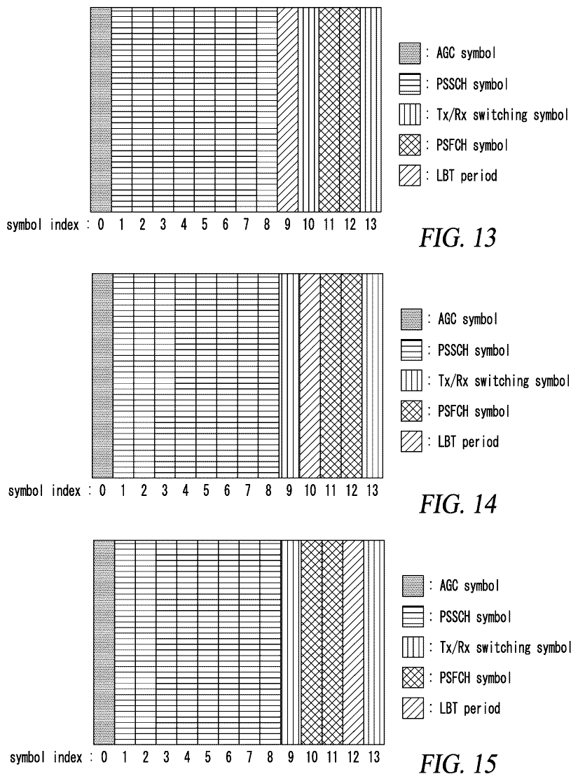

FIG. 13 is a conceptual diagram illustrating a second exemplary embodiment of a slot including an LBT period.

As shown in FIG. 13, a slot may include 14 symbols (e.g., 14 SL symbols), PSFCH symbols may be symbols 11 and 12, and Tx/Rx switching symbols may be symbols 10 and 13. An LBT period may be configured in a portion of or an entire symbol 9 before the symbol 10 (e.g., Tx/Rx switching symbol).

FIG. 14 is a conceptual diagram illustrating a third exemplary embodiment of a slot including an LBT period.

As shown in FIG. 14, a slot may include 14 symbols (e.g., 14 SL symbols), PSFCH symbols may be symbols 11 and 12, and Tx/Rx switching symbols may be symbols 9 and 13. An LBT period may be configured in a portion of or an entire symbol 10 before the symbol 11 (e.g., PSFCH symbol).

FIG. 15 is a conceptual diagram illustrating a fourth exemplary embodiment of a slot including an LBT period.

As shown in FIG. 15, a slot may include 14 symbols (e.g., 14 SL symbols), PSFCH symbols may be symbols 10 and 11, and Tx/Rx switching symbols may be symbols 9 and 13. An LBT period may be configured in a portion of or an entire symbol 12 after the symbol 11 (e.g., PSFCH symbol).

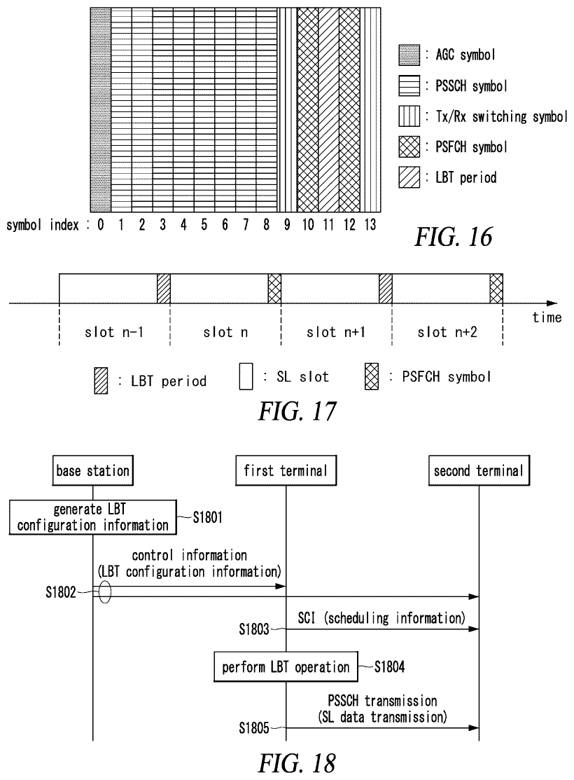

FIG. 16 is a conceptual diagram illustrating a fifth exemplary embodiment of a slot including an LBT period.

As shown in FIG. 16, a slot may include 14 symbols (e.g., 14 SL symbols), PSFCH symbols may be symbols 10 and 12, and Tx/Rx switching symbols may be symbols 9 and 13. An LBT period may be configured in a portion of or an entire symbol 11 located between the symbol 10 and the symbol 12. In other words, the LBT period may be configured in a portion of or the entire symbol 11 located between two PSFCH symbols.

FIG. 17 is a conceptual diagram illustrating a first exemplary embodiment of a slot including an LBT period and/or PSFCH symbol.

Referring to FIG. 17, an LBT periodicity may be associated with a PSFCH periodicity. An LBT period may be configured in a slot in which no PSFCH symbol exists. For example, when the PSFCH periodicity (e.g., sl-PSFCH-Period) is set to two slots, PSFCH symbol(s) may exist in a slot n, slot n+2, slot n+4, etc. In this case, the LBT period may exist in a slot n−1, slot n+1, slot n+3, etc. n may be an integer greater than or equal to 0.

According to the exemplary embodiment of FIG. 17, the LBT period may be configured in a portion (e.g., front half or back half) of a Tx/Rx switching symbol (e.g., symbol 13). Alternatively, the LBT period may be configured in a portion of or an entire symbol preceding the Tx/Rx switching symbol.

Alternatively, the LBT periodicity may be set independently. In other words, the LBT periodicity may be set regardless of the PSFCH periodicity. For example, an LBT period may exist in every slot. In this case, the LBT period may be configured in a portion (e.g., front half or back half) of a Tx/Rx switching symbol (e.g., symbol 13). Alternatively, the LBT period may be configured in a portion of or an entire symbol preceding the Tx/Rx switching symbol. ‘The LBT periodicity is set independently of the PSFCH periodicity’ may mean that PSFCHs are not configured in SL-U communication.

In the present disclosure, SCI may be interpreted as first-stage SCI and/or second-stage SCI. ‘An LBT operation is performed in a Tx/Rx switching symbol’ may mean that the LBT operation is performed in a previous symbol of an AGC symbol. If the LBT operation is performed in a symbol before the AGC symbol, SL transmission may be performed in the unlicensed band without wasting symbol(s) after the LBT operation. In order to minimize a resource remaining after performing the LBT operation within the slot (e.g., SL slot), it may be preferable to limit the period (e.g., the last symbol of the slot) in which the LBT operation is performed within the slot. The above-described operation may be performed to ensure that there is no resource remaining after performing the LBT operation within the slot.

The LBT operation may be configured to be performed at an arbitrary location. To minimize a resource remaining after the LBT operation, a short slot (or mini slot) may be used. The number of symbols included in the short slot may be less than the number of symbols included in a regular slot (e.g., existing slot). In other words, the length of the short slot may be shorter than the length of the regular slot. For example, one short slot may include seven symbols. PSFCH symbol(s) may not be configured in the short slot. In other words, PSFCH symbol(s) may be configured only in the regular slot.

In the short slot including seven symbols, one symbol may be configured as an AGC symbol, five symbols may be configured as PSSCH symbols, and one symbol may be configured as a Tx/Rx switching symbol. It may be preferable to limit a period (e.g., the last symbol of the short slot) in which the LBT operation is performed within the short slot.

When 15 kHz subcarrier spacing (SCS) is used in SL-U communication, the LBT period may be configured within one symbol (e.g., 71.4 μs) considering a slot duration for CCA. The above-described method for configuring the LBT period may be applied in the same or similar manner to SL-U communication in which a SCS other than 15 kHz SCS is used. For example, when a large SCS is used, in order to secure a slot duration for CCA, the LBT period may be configured in two or more symbols. In the present disclosure, the LBT period for SL-U communication may be configured in symbol units or time units. In this case, the above-described operations may be applied identically or similarly.

FIG. 18 is a sequence chart illustrating a first exemplary embodiment of a SL-U communication method.

As shown in FIG. 18, a base station may generate LBT configuration information (S1801). The LBT configuration information may include at least one of an LBT enable/disable indicator, LBT duration information, LBT periodicity information, or LBT offset information. The base station may transmit control information including the LBT configuration information to terminal(s) (S1802). In other words, the control information including the LBT configuration information may be signaled to the terminal(s). The signaling may be at least one of higher layer signaling, MAC signaling, or PHY signaling.

In step S1802, the base station may transmit system information and/or an RRC message including some information elements of the LBT configuration information to the terminal(s), and may transmit a MAC CE (or, DCI) including the remaining information element(s) of the LBT configuration information to the terminal. For example, the LBT enable/disable indicator may be included in the system information and/or RRC messages. When the LBT enable/disable indicator indicates enabling of the LBT operation, at least one of the LBT duration information, LBT periodicity information, or LBT offset information may be included in the MAC CE (or DCI). A first terminal and/or a second terminal may receive the control information from the base station, and identify the LBT configuration information included in the control information.

When SL data to be transmitted to the second terminal exists in the first terminal, the first terminal may generate SCI (e.g., first-stage SCI and/or second-stage SCI) including scheduling information of the SL data. Transmission of the SL data (e.g., PSSCH) may be performed in a licensed band or unlicensed band. Information indicating that transmission of the PSSCH is performed in the unlicensed band and/or information on a frequency resource in which transmission of the PSSCH is performed (e.g., information indicating a frequency resource in the unlicensed band) may be included in the SCI. The first terminal may transmit the SCI to the second terminal (S1803).

The first terminal and/or the second terminal may support a carrier aggregation (CA) function. The SCI of the first terminal may be transmitted in the licensed band or unlicensed band. When transmission of the SCI is performed in the unlicensed band, the first terminal in the unlicensed band may identify an LBT period based on the LBT configuration information and perform an LBT operation in the LBT period. If a result of the LBT operation indicates an idle state, the first terminal may transmit the SCI to the second terminal. Alternatively, in the unlicensed band, the first terminal may transmit the SCI to the second terminal without performing the LBT operation. In other words, the LBT configuration information (e.g., LBT operation) may not be applied to transmission of the SCI.

The second terminal may receive the SCI from the first terminal and identify the scheduling information of the SL data included in the SCI. The second terminal may perform a reception operation of the SL data based on the scheduling information. When the SCI indicates that transmission of the SL data is performed in the unlicensed band, the second terminal may perform a reception operation of the SL data in the unlicensed band. When the SCI indicates that transmission of the SL data is performed in the licensed band, the second terminal may perform a reception operation of the SL data in the licensed band.

When transmission of the SL data is performed in the licensed band, the first terminal may perform a transmission operation of the SL data based on the scheduling information included in the SCI (S1805). When transmission of the SL data is performed in the unlicensed band, the first terminal may perform an LBT operation based on the LBT configuration information in the unlicensed band (S1804). For example, the first terminal may identify an LBT period based on the LBT configuration information (e.g., LBT duration information, LBT periodicity information, and/or LBT offset information) and perform an LBT operation in the LBT period. If a result of the LBT operation indicates an idle state, the first terminal may transmit the SL data to the second terminal (S1805). If the result of the LBT operation indicates a busy state, the first terminal may not perform transmission of the SL data.

As another method, the first terminal may transmit the SL data to the second terminal without performing an LBT operation in the unlicensed band. If the SCI indicates not to apply the LBT operation, the first terminal may transmit the SL data without performing an LBT operation in the unlicensed band. Alternatively, if the SL data is urgent data, the first terminal may transmit the SL data without performing an LBT operation in the unlicensed band. Alternatively, if SL-U communication is performed within a COT and SCI is transmitted based on an LBT operation, the first terminal may transmit SL data scheduled by the SCI within the COT without performing an LBT operation. The COT may be initiated by the first terminal. Alternatively, a base station may initiate the COT and share the COT with the first terminal. In this case, the first terminal may perform SL-U communication (e.g., SCI transmission, SL data transmission) within the COT shared by the base station.

The second terminal may receive the SL data from the first terminal, and transmit a HARQ-ACK feedback for the SL data to the first terminal. Alternatively, a HARQ-ACK feedback transmission operation may be omitted. If transmission of the SL data is performed in the licensed band, a HARQ-ACK feedback for the SL data may be transmitted. If transmission of the SL data is performed in the unlicensed band, transmission of a HARQ-ACK feedback for the SL data may be omitted.

In the above-described SL-U communication, the LBT configuration information may be configured specifically, independently, or commonly based on at least one of a resource pool, service type, priority, whether a power saving operation is performed, QoS parameters (e.g., reliability, latency), cast type, or terminal type (e.g., vehicle (V)-UE or pedestrian (P)-UE). The above-described configuration may be performed by the network and/or base station. Alternatively, the above-described information may be implicitly determined based on preconfigured parameter(s).

In the above-described exemplary embodiment, whether or not to apply each method (e.g., each rule) may be configured based on at least one of a condition, a combination of conditions, a parameter, or a combination of parameters. Whether or not to apply each method may be configured by the network and/or base station. Whether or not to apply each method may be configured specifically for a resource pool or service. Alternatively, whether or not to apply each method may be configured by PC5-RRC signaling between terminals.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of operating a first user equipment (UE), the method comprising:
receiving, by a processor of the first UE, listen-before-talk (LBT) configuration information;
identifying, by the processor, an LBT period based on the LBT configuration information;
performing, by the processor, an LBT operation in the LBT period; and
in response to a result of the LBT operation indicating an idle state, performing, by the processor, sidelink (SL) communication with a second UE.

2. The method of claim 1, wherein the LBT configuration information includes at least one of an LBT enable/disable indicator, LBT duration information, LBT periodicity information, or LBT offset information.

3. The method of claim 2, wherein identifying the LBT period further comprises: selecting an LBT duration corresponding to a priority of SL data based on the LBT duration information, and a length of the LBT period is the LBT duration.

4. The method of claim 2, wherein an LBT periodicity indicated by the LBT periodicity information is configured to be associated with a physical sidelink feedback channel (PSFCH) periodicity.

5. The method of claim 2, wherein an LBT periodicity indicated by the LBT periodicity information is set to be shorter as the priority of the SL data is higher, and the LBT periodicity is set to be longer as the priority of the SL data is lower.

6. The method of claim 1, wherein the LBT configuration information is received through at least one of higher layer signaling, medium access control (MAC) signaling, or physical (PHY) signaling of the base station.

7. The method of claim 1, wherein the LBT period is configured in a portion of or an entire PSFCH symbol within a slot, a portion of or an entire symbol before the PSFCH symbol, a portion of or an entire symbol after the PSFCH symbol, a portion of or an entire Tx/Rx switching symbol, a portion of or an entire symbol before the Tx/Rx switching symbol, or a portion of or an entire symbol after the Tx/Rx switching symbol.

8. The method of claim 1, wherein performing the SL communication with the second UE comprises: transmitting SL data to the second UE in an unlicensed band, and sidelink control information (SCI) including scheduling information of the SL data is transmitted to the second UE in a licensed band or the unlicensed band.

9. The method of claim 8, wherein when the SCI is transmitted in the unlicensed band, the LBT operation is divided into a first LBT operation for transmission of the SCI and a second LBT operation for transmission of the SL data.

10. The method of claim 1, wherein performing the SL communication with the second UE comprises: transmitting SCI to the second UE within a channel occupancy time (COT) of an unlicensed band, and SL data scheduled by the SCI is transmitted to the second UE within the COT without performing the LBT operation.

11. A first user equipment (UE), comprising:
at least one processor, wherein the at least one processor causes the first UE to perform:
receiving listen-before-talk (LBT) configuration information;
identifying an LBT period based on the LBT configuration information;
performing an LBT operation in the LBT period; and
in response to a result of the LBT operation indicating an idle state, performing sidelink (SL) communication with a second UE.

12. The first UE of claim 11, wherein the LBT configuration information includes at least one of an LBT enable/disable indicator, LBT duration information, LBT periodicity information, or LBT offset information.

13. The first UE of claim 12, wherein in the identifying of the LBT period, the processor causes the first UE to perform: selecting an LBT duration corresponding to a priority of SL data based on the LBT duration information, and a length of the LBT period is the LBT duration.

14. The first UE of claim 12, wherein an LBT periodicity indicated by the LBT periodicity information is configured to be associated with a physical sidelink feedback channel (PSFCH) periodicity.

15. The first UE of claim 12, wherein an LBT periodicity indicated by the LBT periodicity information is set to be shorter as the priority of the SL data is higher, and the LBT periodicity is set to be longer as the priority of the SL data is lower.

16. The first UE of claim 11, wherein the LBT configuration information is received through at least one of higher layer signaling, medium access control (MAC) signaling, or physical (PHY) signaling of the base station.

17. The first UE of claim 11, wherein the LBT period is configured in a portion of or an entire PSFCH symbol within a slot, a portion of or an entire symbol before the PSFCH symbol, a portion of or an entire symbol after the PSFCH symbol, a portion of or an entire Tx/Rx switching symbol, a portion of or an entire symbol before the Tx/Rx switching symbol, or a portion of or an entire symbol after the Tx/Rx switching symbol.

18. The first UE of claim 11, wherein in performing the SL communication with the second UE, the processor causes the first UE to perform: transmitting SL data to the second UE in an unlicensed band, and sidelink control information (SCI) including scheduling information of the SL data is transmitted to the second UE in a licensed band or the unlicensed band.

19. The first UE of claim 18, wherein when the SCI is transmitted in the unlicensed band, the LBT operation is divided into a first LBT operation for transmission of the SCI and a second LBT operation for transmission of the SL data.

20. The first UE of claim 11, wherein in performing the SL communication with the second UE, the processor causes the first UE to perform: transmitting SCI to the second UE within a channel occupancy time (COT) of an unlicensed band, and SL data scheduled by the SCI is transmitted to the second UE within the COT without performing the LBT operation.
